(19) United States
(12) Patent Application Publication
(10) Pub. No.: US 2009/0097869 A1
(43) Pub. Date: Apr. 16, 2009

(54) Image Forming Apparatus, Toner Consumption Calculation Method and Method of Deriving Toner Consumption Base Data for Use Therein

(75) Inventors: Hironobu KONO, Shiojiri-shi (JP); Isao INABA, Suwa-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/247,087

(22) Filed: Oct. 7, 2008

(30) Foreign Application Priority Data
Oct. 12, 2007 (JP) 2007-266724
Oct. 12, 2007 (JP) 2007-266725

(51) Int. Cl. G03G 15/08

(52) U.S. Cl. 399/27

(57) ABSTRACT

An image forming apparatus comprises: a photosensitive member that revolvably moves in a moving direction; an exposure device that exposes a surface of the photosensitive member to a light beam which is controllably activated according to an image signal and scanned on the surface of the photosensitive member in a scanning direction perpendicular to the moving direction thereof, thereby forming an electrostatic latent image on the photosensitive member in correspondence to the image signal; a developing device that develops the electrostatic latent image with a toner to form a toner image; and a toner consumption calculator that counts the number of dots constituting the toner image based on the image signal and calculates a quantity of toner consumed by the developing device based on the resultant count value, wherein the toner consumption calculator calculates a toner consumption based on the count value of the dots weighted according to the number of consecutive dots in the scanning direction, and the magnitude of weighted amount is determined based on toner consumption base data representing a toner consumption on a line-patterned toner image which has a line pattern including a component in the moving direction and being formed with a line width corresponding to a consecutive dot number.

### CROSS REFERENCE TO RELATED APPLICATION

The disclosure of Japanese Patent Applications No. 2007-266724 filed on Oct. 12, 2007 and No. 2007-266725 filed on Oct. 12, 2007 including specification, drawings and claims is incorporated herein by reference in its entirety.

### BACKGROUND

1. Technical Field

The present invention relates to an image forming apparatus and a toner consumption calculation method wherein toner consumption is calculated based on an image signal as well as to a method of deriving toner consumption base data for use in such image forming apparatus and toner consumption calculation method.

2. Related Art

In an image forming apparatus which forms an image by using a toner, a technique for calculating the toner consumption has heretofore been proposed. In particular, the toner consumption is calculated based on the number of dots constituting an image and toner consumption base data which corresponds to the toner consumption per dot According to a technique previously disclosed by the present inventors in JP-A-2005-208090 (FIG. 6, FIG. 7), for example, the total toner consumption is determined as follows. In view of the fact that the quantity of toner constituting a toner dot varies depending upon the size thereof, the dots are classified by size and the number of formed dots is counted on a per-dot-size basis. The count value thus obtained is multiplied by a coefficient equivalent to an adherent toner percentage corresponding to the dot size, whereby the whole toner consumption is obtained.

According to this technique, the quantities of toner adherent to dots having different lengths in a main scanning direction (a scanning direction of a light beam relative to a surface of a photosensitive member) are discretely determined. A relation between the dot size and the quantity of adherent toner is previously quantified so as to be applied to the calculation of toner consumption.

### SUMMARY

The above-described technique does not consider the consecutiveness of dots in a sub scanning direction (a direction perpendicular to the main scanning direction in which the light beam is scanned). However, an actual image is constituted by dots two-dimensionally scattered in the main scanning direction and the sub scanning direction. The consecutiveness of dots in the sub scanning direction also affects the respective quantities of adherent toner thereon. In order to calculate the toner consumption with higher accuracies, therefore, it is essential to consider the consecutiveness of dots in the sub scanning direction as well. The sizes of dots in the main scanning direction can be relatively easily determined by analyzing the image signals in time series while a complicated processing is required for determining, from the image signals, a dot arrangement in the sub scanning direction or a distribution of dots located at coincident positions in the main scanning direction but at different positions in the sub scanning direction. Because of this, a toner consumption calculation technique also considering the consecutiveness of dots in the sub scanning direction has not been put to practical use.

An advantage of some aspects of the invention is to provide a toner consumption calculation technique, despite a simple method, which takes the consecutiveness of dots in the scanning direction of the light beam and in the direction perpendicular thereto into consideration so as to calculate a toner consumption with high accuracy.

An image forming apparatus according to an aspect of the invention comprises: a photosensitive member that revolvably moves in a moving direction; an exposure device that exposes a surface of the photosensitive member to a light beam which is controllably activated according to an image signal and scanned on the surface of the photosensitive member in a scanning direction perpendicular to the moving direction thereof; thereby forming an electrostatic latent image on the photosensitive member in correspondence to the image signal; a developing device that develops the electrostatic latent image with a toner to form a toner image; and a toner consumption calculator that counts the number of dots constituting the toner image based on the image signal and calculates a quantity of toner consumed by the developing device based on the resultant count value, wherein the toner consumption calculator calculates a toner consumption based on the count value of the dots weighted according to the number of consecutive dots in the scanning direction, and the magnitude of weighted amount is determined based on toner consumption base data representing a toner consumption on a line-patterned toner image which has a line pattern including a component in the moving direction and being formed with a line width corresponding to a consecutive dot number.

A toner consumption calculation method according to an aspect of the invention is a method of calculating a toner consumption in an image forming apparatus which forms an electrostatic latent image corresponding to an image signal on a surface of a revolvably moved photosensitive member by scanning a light beam, controllably activated according to the image signal, on the surface of the photosensitive member in a direction perpendicular to the moving direction of the surface of the photosensitive member and which forms a toner image by developing the electrostatic latent image with a toner. The method comprises: counting the number of dots constituting the toner image based on the image signal; weighting the resultant count value according to the number of consecutive dots in the scanning direction of the light beam; and obtaining a toner consumption based on the weighted value, wherein the magnitude of weighted amount is determined based on toner consumption base data representing a toner consumption on a line-patterned toner image formed in a line pattern having a line width corresponding to a consecutive dot number and including a component in the moving direction.

Hereinafter, the scanning direction of the light beam relative to the surface of the photosensitive member will be referred to as a “main scanning direction”, while the moving direction of the photosensitive member surface which is perpendicular to the main scanning direction will be referred to as a “sub scanning direction”. In the above image forming apparatus, the surface of the photosensitive member is moved in the sub scanning direction while scanning the light beam thereon in the main scanning direction, whereby the electrostatic latent image corresponding to a two-dimensional image is formed on the photosensitive member

In the invention of the above constitution, the toner consumption is calculated based on the dot count weighted according to the number of consecutive dots in the main scanning direction. Furthermore, the weighted dot count includes the component in the sub scanning direction. In other words, the toner consumption is also calculated based on the toner consumption on the line-patterned toner image having the consecutive dots in the sub scanning direction. In this manner, the weighting is varied according to the number of consecutive dots in the main scanning direction and the magnitude of weighted amount itself is determined based on the toner consumption on the line-patterned toner image including the component in the sub scanning direction, so that the consecutiveness of dots in both the main scanning direction and the sub scanning direction is incorporated in the weighted dot count. Accordingly, the quantity of toner consumed by forming image can be calculated more accurately. The invention does not require the dot arrangement in the sub scanning direction in the actual image based on the image signal. Therefore, if the toner consumption base data is previously obtained, it is easy to execute the subsequent processing for calculating the toner consumption.

A toner consumption base data deriving method according to an aspect of the invention is a method of deriving toner consumption base data for use in an image forming apparatus which forms an electrostatic latent image corresponding to an image signal on a surface of a revolvably moved photosensitive member by scanning a light beam, controllably activated according to the image signal, on the surface of the photosensitive member in a scanning direction perpendicular to the moving direction of the surface of the photosensitive member, which forms a toner image by developing the electrostatic latent image with a toner, and which calculates a toner consumption based on a count value of dots constituting the toner image, the count value weighted based on toner consumption base data corresponding to per-dot toner consumption. The method comprises: performing a measuring step of forming, on the surface of the photosensitive member, a line-patterned toner image which has a predetermined line width and includes a component in the moving direction, measuring a quantity of toner consumed for forming the line-patterned toner image, and determining from the measurement result a per-dot toner consumption on the line-patterned toner image, wherein the measuring step is repeated while the line width is varied in plural values, and data, which is acquired by these measuring steps and represents a relation between the line width and the per-dot toner consumption, is used as the toner consumption base data.

According to the invention of the above constitution, the toner consumption base data incorporating the consecutiveness of dots in both the main scanning direction and the sub scanning direction can be derived. The reason is as follows. In the method of deriving toner consumption base data according to the invention, the line-patterned toner image including the component in the moving direction of the surface of the photosensitive member, namely in the sub scanning direction is formed. In such a line-patterned toner image, one line is constituted by dots consecutively arranged in the sub scanning direction. Therefore, the consecutiveness of dots in the sub scanning direction is reflected in the quantity of toner consumed for forming the line-patterned toner image. Further, the width of the line including the component in the sub scanning direction is dependent upon the number of consecutive dots in the main scanning direction. Hence, the consecutiveness of dots in the main scanning direction is reflected in the toner consumptions on the line-patterned toner images formed with the line width set variedly.

According to the invention, the line-patterned toner image is formed in which the consecutiveness of dots in both the main scanning direction and the sub scanning direction is reflected. Therefore, the toner consumption base data can be acquired with good accuracies based on the toner consumption on this line-patterned toner image. Further, the toner consumption base data comprises the data representing the relation between the line width and the per-dot toner consumption. In a real image forming apparatus to which the toner consumption base data acquired according to the invention is applied, it is possible to determine the toner consumption per dot with high accuracies if the consecutiveness between each of the dots constituting the image and its adjoining dot(s) in the main scanning direction is known.

The toner consumption base data acquired by the deriving method of the invention may be used for setting a correction coefficient for a toner counter disclosed in JP-A-2005-208090 above.

The above and further objects and novel features of the invention will more fully appear from the following detailed description when the same is read in connection with the accompanying drawing. It is to be expressly understood, however, that the drawing is for purpose of illustration only and is not intended as a definition of the limits of the invention.

### BRIEF DESCRIPTION OF THE DRAWINGS

FIG. 1 is a diagram showing an embodiment of an image forming apparatus to which the invention may be favorably applied;

FIG. 2 is a block diagram showing an electrical arrangement of the image forming apparatus of FIG. 1;

FIG. 3 is a block diagram showing a signal processor in the image forming apparatus of FIG. 1;

FIG. 4A and FIG. 4B are diagrams showing line images;

FIG. 5 is a graph showing the toner consumption on the line image;

FIG. 6A and FIG. 6B are diagrams showing the models for explaining the difference between the line in the main scanning direction and the line in the sub scanning direction;

FIG. 7 is a flow chart showing the steps of the method of deriving the toner consumption base data;

FIG. 8A. FIG. 8B and FIG. 8C are schematic diagrams each showing a relation between the line width and the line-to-line space of a line image;

FIG. 9A is a graph showing the principle of generating the coefficient table;

FIG. 9B is one of the coefficient tables;

FIG. 10 is a diagram showing a model of the toner counter;

FIG. 11 is a graph showing a relation between the toner deterioration and the toner consumption;

FIG. 12 is a chart showing another example of the method of deriving the toner consumption base data; and

FIG. 13 is a diagram showing another example of the line image.

### DESCRIPTION OF EXEMPLARY EMBODIMENT

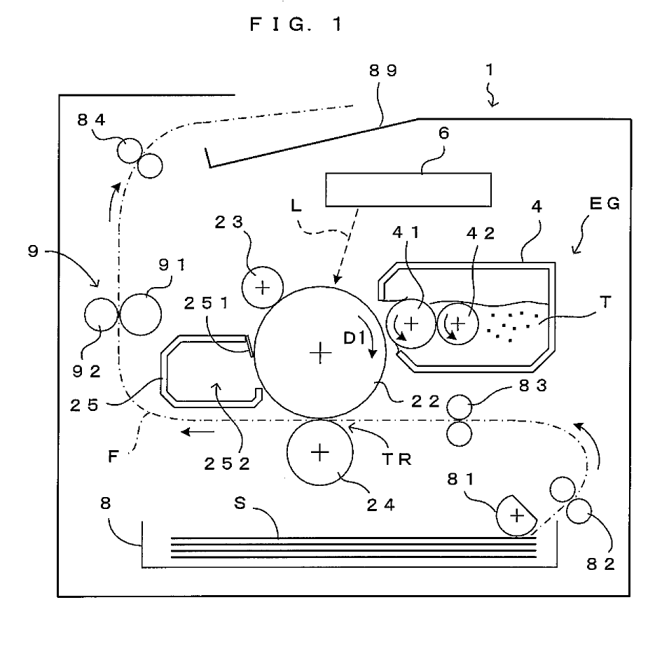

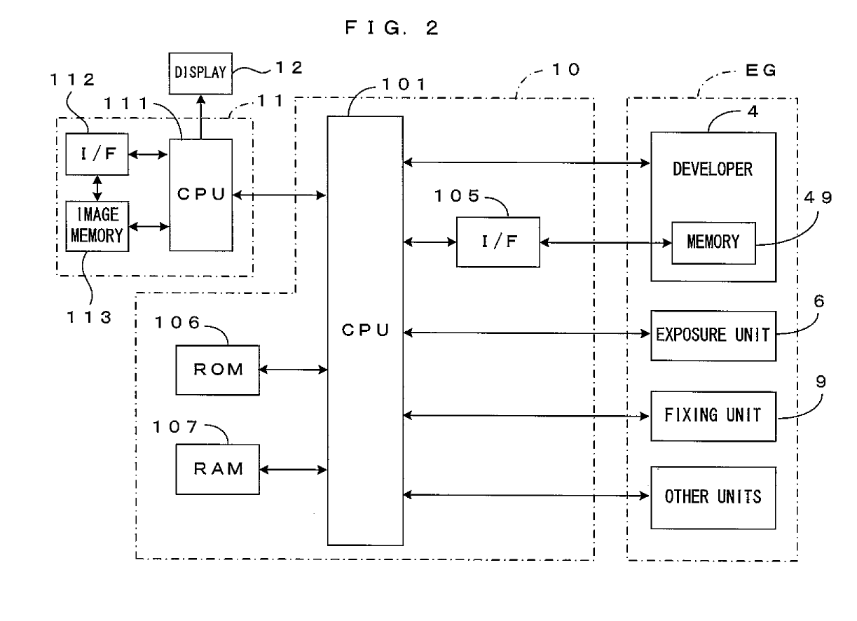

FIG. 1 is a diagram showing an embodiment of an image forming apparatus to which the invention may be favorably applied. FIG. 2 is a block diagram showing an electrical arrangement of the image forming apparatus of FIG. 1. This image forming apparatus 1 is one which performs an image forming operation in response to an image forming command supplied from an external apparatus such as a host computer, thereby to form a monochromatic image corresponding to an image signal. The image forming apparatus 1 operates as follows. When the external apparatus such as the host computer supplies the image forming command to a main controller 11 including a CPU 111, an image memory 113 and the like via an interface (I/F) 112, the main controller 11 supplies a control signal to an engine controller 10. Based on the control signal, the engine controller 10 controls individual parts of the apparatus, such as an engine EG, so that a predetermined image forming operation is performed to form an image corresponding to the image forming command on a sheet S as a recording material such as copy sheet, transfer sheet, paper and transparent sheet for OHP.

The engine EG of the image forming apparatus comprises a photosensitive member 22, a charging roller 23, an exposure unit 6, a developer 4 and the like. More specifically, the engine EG is provided with the photosensitive member 22 shaped like a drum and free to rotate about a rotational axis perpendicular to the drawing surface of FIG. 1. The photosensitive member 22 is driven into rotation by an unillustrated driving mechanism so that the photosensitive member rotates at a constant speed in a direction of an arrow D1 in FIG. 1. The charging roller 23, the exposure unit 6, the developer 4, a transfer roller 24 and a cleaner 25 are arranged around the photosensitive member 22 in this order and in the direction of rotation thereof.

A surface of the photosensitive member 22 is charged to a predetermined surface potential by means of the charging roller 23 which is supplied with a predetermined charging bias and abuts against the surface of the photosensitive member 22. The exposure unit 6 irradiates a light beam L upon the photosensitive member 22 thus charged. The exposure unit 6 comprises a laser scan unit (LSU) which includes a laser light source controllably activated according to an image signal included in the image forming command supplied from the external apparatus, and a light deflection system for deflecting the laser beam outputted from the laser light source so as to make the laser beam incident on the photosensitive member 22. The laser scan unit operates a scanning mechanism including a rotating polygon mirror and the like so as to scan the laser beam in a direction perpendicular to the moving direction D1 of the photosensitive member 22. Namely, the laser scan unit scans the laser beam in the direction perpendicular to the drawing surface of FIG. 1. In this manner, the exposure unit 6 scans the laser beam on the surface of the photosensitive member 22 according to the image signal thereby to form an electrostatic latent image on the photosensitive member 22 in correspondence to the image signal. Hereinafter, the scanning direction of the light beam L will be referred to as the “main scanning direction” while the direction perpendicular thereto, or the moving direction of the surface of the photosensitive member 22 will be referred to as the “sub scanning direction”.

The electrostatic latent image thus formed on the photosensitive member 22 is developed with a toner stored in the developer 4. Specifically, the developer 4 stores therein a black toner T and is provided with a developing roller 41 and a feed roller 42. The developing roller 41 and the feed roller 42 are each driven into rotation in a direction of an arrow shown in FIG. 1 whereby the toner T is rubbed on the developing roller 41, which carries a predetermined quantity of toner thereon. The developing roller 41 opposes the surface of the photosensitive member 22 via a predetermined gap therebetween and is applied with a predetermined developing bias from an unillustrated developing bias generator. Hence, the toner carried on the developing roller 41 and delivered to place opposite the photosensitive member 22 is transferred to the photosensitive member 22 whereby the electrostatic latent image on the photosensitive member 22 is visualized as a toner image.

The toner image thus visualized is transferred to the sheet S at a transfer position TR. A cassette 8 storing the sheets S therein is disposed under the engine EG. On the other hand, a pickup roller 81, pairs of sheet transporting rollers 82, 83, 84 constitute a transport path F for transporting the sheet S from the cassette 8 to a discharge tray 89 on a top of the apparatus via the transfer position TR. The arrows near the transport path F indicate a sheet transporting direction at respective places. The pickup roller 8 takes out the sheet S, one by one, from the cassette 8. The sheet so taken out is transported along the transport path F to the transfer position TR. At the transfer portion TR, the toner image on the photosensitive member 22 is transferred to the sheet S when the sheet S is passed through a nip where the photosensitive member 22 and the transfer roller 24 abut against each other.

After image transfer, the surface of the photosensitive member 22 is cleaned by the cleaner 25. The cleaner 25 includes a cleaner blade 251 abutting against the surface of the photosensitive member 22 for scraping off residual toner thereon, and a waste toner tank 252 for storing the toner thus scraped off. The surface of the photosensitive member 22 thus removed of the residual toner is charged again by the charging roller 23 and subjected to the subsequent image formation.

After receiving the toner image at the transfer position F, the sheet S is transported along the transport path F to be fed into a fixing unit 9. The fixing unit 9 comprises a heating roller 91 containing therein a heater and heated to a predetermined temperature, and a pressing roller 92 pressed against the heating roller 91. The fixing unit fixes the toner image onto the sheet S by heating and pressing the toner when the sheet S with the toner image transferred thereto is passed through a nip between the heating roller 91 and the pressing roller 92 pressed against each other The sheet S with the toner image thus fixed thereto is discharged to the discharge tray 89 disposed on the top of the apparatus.

Further, as shown in FIG. 2, the apparatus 1 comprises a display 12 which is controlled by the CPU 111 of the main controller 11. The display 12 is formed by a liquid crystal display for instance, and shows predetermined messages which are indicative of guidance on user operations, a status of a progress in the image forming operation, abnormality in the apparatus, the timing of exchanging any one of the units, etc.

The developer 4 is provided with a non-volatile memory 49 for storing information on the developer of interest. The non-volatile memory 49 installed in the developer is connected to a CPU 101 of the engine controller 10 via a memory interface 105 so that communications may be carried out between the CPU 101 and the memory 49. Thus, the information on the developer is transmitted to the CPU 101 while information in the memory 49 is updated and stored.

In FIG. 2, a reference numeral 113 represents an image memory provided in the main controller 11 in order to store the image supplied from the external apparatus, such as a host computer, via the interface 112. A reference numeral 106 represents a ROM for storage of an operation program executed by the CPU 101 and control data used for controlling the engine EG. A reference numeral 107 represents a RAM for temporary storage of operation results given by the CPU 101 and other data.

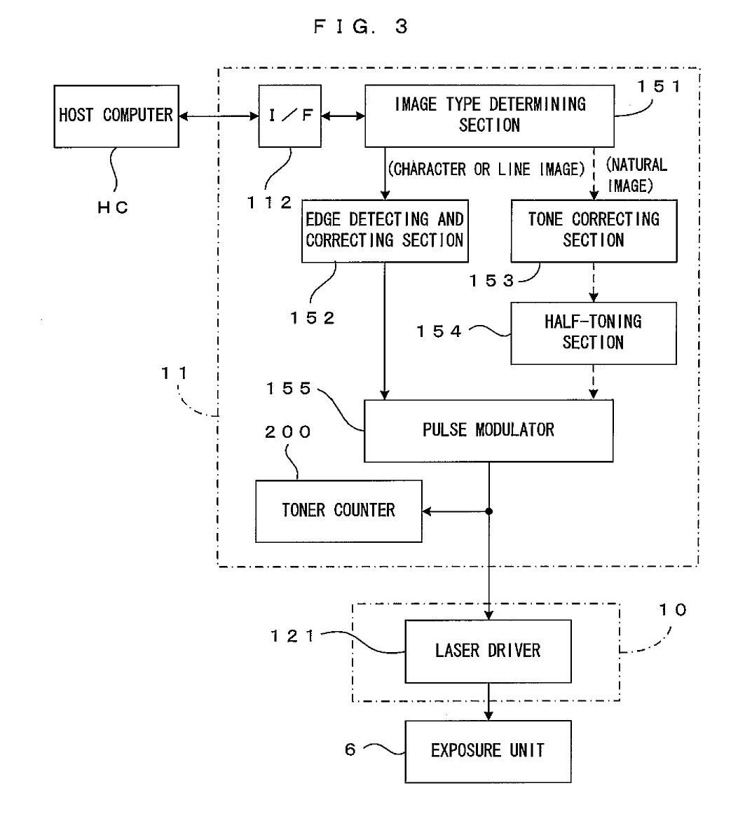

FIG. 3 is a block diagram showing a signal processor in the image forming apparatus of FIG. 1. The CPU 111 disposed in the main controller 11 executes a previously written program to function as the signal processor. The signal processor comprises function blocks including an image type determining section 151, an edge detecting and correcting section 152, a tone correcting section 153, a half-toning section 154, a pulse modulator 155 and the like.

The image type determining section 151 determines a type of image to be formed, referring to the image forming command supplied from a host computer HC via the interface 112. Specifically, the section 151 determines whether the image to be formed is an image principally composed of characters and line drawing (character or line image) or a natural image such as a photographic image.

In a case where the image to be formed is the character or line image, the image type determining section 151 sends the image signal to the edge detecting and correcting section 152. The edge detecting and correcting section 152 processes the image signal so as to provide a more smoothly outlined image by correcting an outline of the character image formed as a dot assembly. A processing technique set forth in Japanese Patent No. 2940266, for example, may be applied to such a signal processing.

On the other hand, in a case where the image to be formed is the natural image, the image type determining section 151 sends the image signal to the tone correcting section 153, as indicated by the broken line in FIG. 3. The tone correcting section 153 performs a tone correction processing on the image signal and outputs the resultant signal to the half-toning section 154. The half-toning section 154 performs a half-tone processing on the tone corrected image signal supplied thereto. Since the tone correction processing and the half-tone processing are known techniques in the art, the description thereof is dispensed with.

The signal outputted from the edge detecting and correcting section 152 or the half-toning section 154 is inputted to the pulse modulator 155. The pulse modulator 155 converts the image signal to a binary signal corresponding to On or Off of the dot and outputs the binary signal. The binary signal is supplied to a laser driver 121 disposed in the engine controller 10 and operative to drive the laser light source. Based on the binary signal, the laser driver 121 controllably activates the laser light source disposed in the exposure unit 6. This signal is also inputted to a toner counter 200 disposed in the main controller 11. Based on this signal, the toner counter 200 counts the number of formed dots. Based on the count value, the toner counter calculates a quantity of toner consumed for forming the toner image.

Next, description will be made on the principle of the toner consumption calculation technique used in the image forming apparatus 1 and specific embodiments thereof. As also stated in JP-A-2005-208090, it is already known that the per-dot toner consumption varies depending upon the consecutiveness of dots constituting the image. The present inventors further conducted various experiments on a relation between the image contents and the toner consumption. Consequently, the inventors have devised the toner consumption calculation technique described as below.

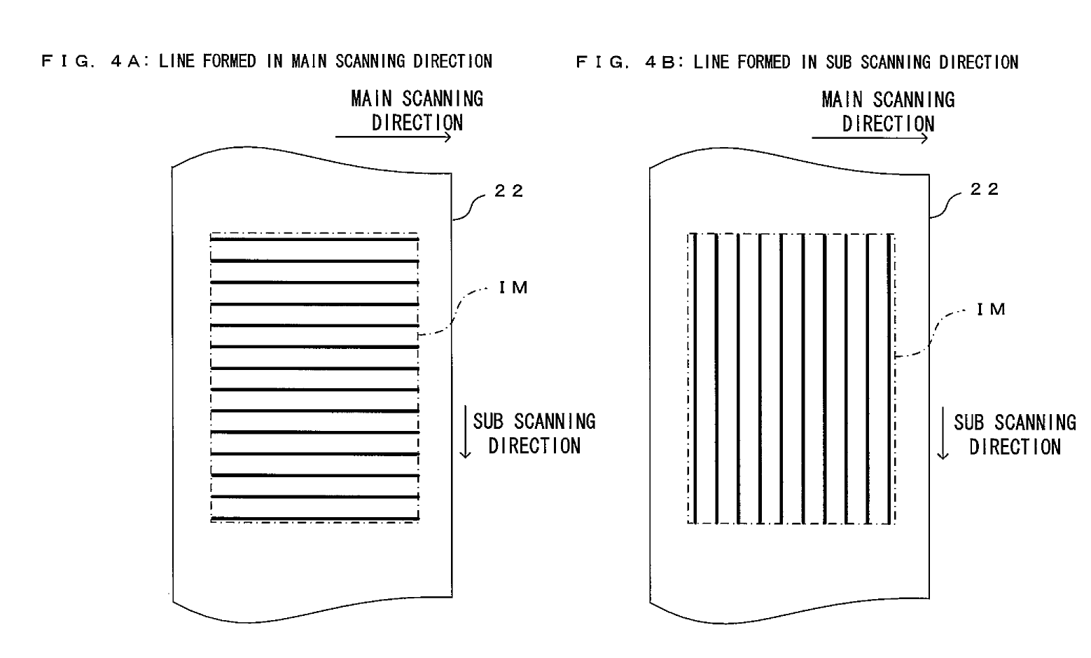

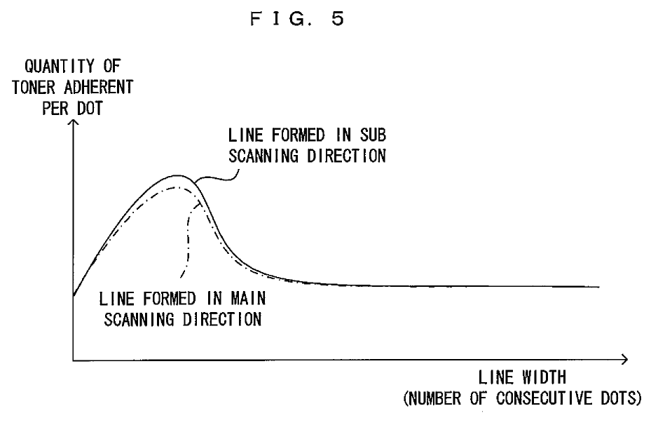

FIG. 4A and FIG. 4B are diagrams showing line images. FIG. 5 is a graph showing the toner consumption on the line image. The inventors took measurement on the per-dot toner consumption on an image region IN of the surface of the photosensitive member 22, the line width of which image region was changed variedly. As shown in FIG. 5, with the progressive increase of the line width, the toner consumption first increases and then, decreases to approach a constant value. In the experiment conducted by the inventors, an apparatus having a resolution of 600 dpi consumed the maximum quantity of toner to form a line image having a width on the order of 5 dots. The toner consumption was compared between a case where plural parallel lines were formed in the main scanning direction, as shown in FIG. 4A, and a case where plural parallel lines were formed in the sub scanning direction, as shown in FIG. 4B. In the image regions having smaller line widths, the lines in the sub scanning direction generally tend to be increased in the toner consumption. In the image regions having greater widths, on the other hand, there was observed little difference in the toner consumption between the lines in the main scanning direction and the lines in the sub scanning direction. To explain this tendency, the following models, for example, may be considered.

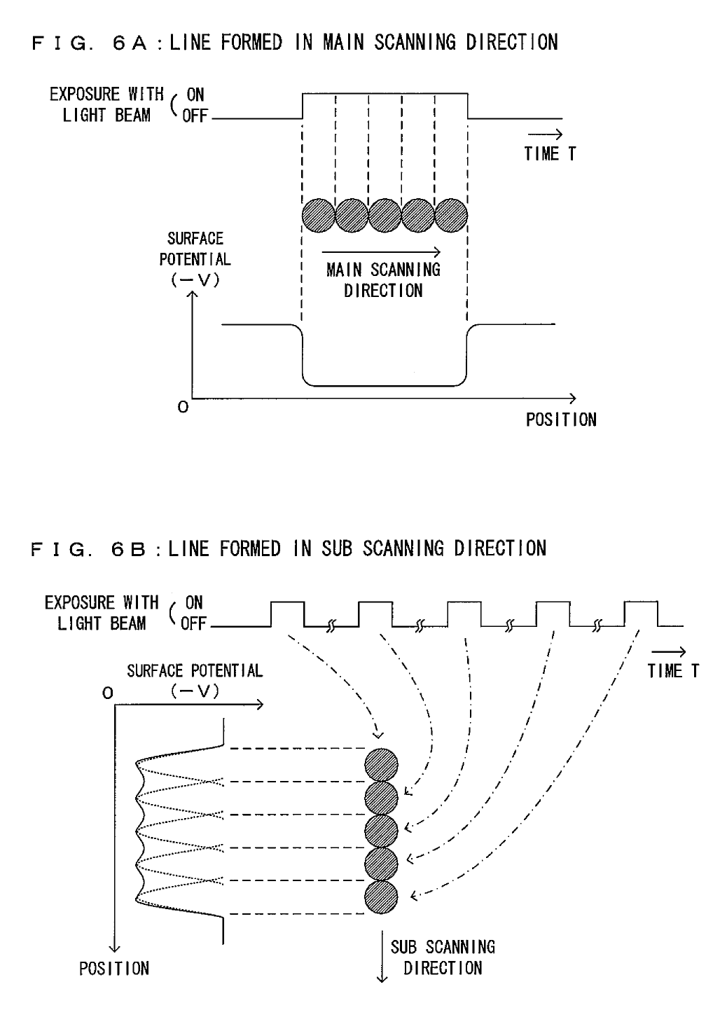

FIG. 6A and FIG. 6B are diagrams showing the models for explaining the difference between the line in the main scanning direction and the line in the sub scanning direction. As shown in FIG. 6A, the line in the main scanning direction is composed of dots consecutively arranged in the main scanning direction. Such a string of consecutive dots is formed by scanning the laser beam from the exposure unit 6 on the surface of the photosensitive member 22 as successively activating the laser light. In a latent image profile (potential distribution) on the surface of the photosensitive member 22, therefore, regions exposed to the laser beam have a substantially constant potential.

As shown in FIG. 6B, on the other hand, the line in the sub scanning direction is formed as follows. Only one-dot length of the line is formed in one scanning cycle of the laser beam. The formation of one-dot length is repeated in plural scanning cycles of the laser beam whereby a predetermined length of line is formed. In this case, the laser beam is intermittently irradiated on the surface of the photosensitive member 22 and hence, a latent image profile of the exposed region is not flat. If the exposed region does not have an even potential, a localized electric field attracts more toner. This is thought to be a factor to increase the toner consumption on the line in the sub scanning direction.

This is particularly significant when one laser-on time is short or when the line width is small. The surface potential of the photosensitive member 22 is sufficiently decreased even in a line in the sub scanning direction, which is increased in the line width, because the laser beam is successively scanned in the main scanning direction in correspondence to the increased line width. Hence, the above-described difference is less likely to occur, which agrees with the experiment results.

In the conventional toner consumption calculation technique, the number of formed dots is integrated as varying the weighting according to the consecutiveness of dots in the main scanning direction. Then, the toner consumption is calculated based on the integrated value. Unfortunately, the consecutiveness of dots in the sub scanning direction is not considered when the magnitude of weighted amount is determined. However, an actual image comprises a mixture of various dot strings in the main scanning direction and sub scanning direction. Furthermore, the toner consumption differs between strings including the same number of consecutive dots in the main scanning direction and in the sub scanning direction, as described above. It is therefore necessary to incorporate the consecutiveness of dots in the sub scanning direction in order to calculate the toner consumption with higher accuracies.

Particularly in a case where a residual toner quantity is calculated for the purpose of managing residual toner quantity, a sufficient effect may not be obtained unless the calculation counts in the dot consecutiveness in the sub scanning direction, which has a greater influence on the toner consumption. The reason is as follows. In a case where the calculation counts in only the dot consecutiveness in the main scanning direction, the calculation gives less calculational toner consumption than a value given by the calculation counting in the dot consecutiveness in the sub scanning direction. This may possibly entail a problem that there is actually left little toner to be used although the calculational value indicates some toner left to be used.

However, the number of dots consecutively arranged in the main scanning direction can be relatively easily detected by, for example, counting the number of pulses applied to the laser driver 61 or counting the width thereof. In contrast, it is not easy to detect the number of dots consecutively arranged in the sub scanning direction because pulses corresponding to the respective dots are outputted in different timings.

The inventors experimented with various images to find that the following approach may be adopted to calculate the toner consumption with sufficient accuracies even though the dot consecutiveness in the sub scanning direction in the actual image is not detected. When the dot count is weighted according to the dot consecutiveness in the main scanning direction, toner consumption base data as the basis of the weighting may be set based on the measurement results of toner consumption on lines formed in various line widths and extending in the sub scanning direction. A specific method of deriving the toner consumption base data is described as below.

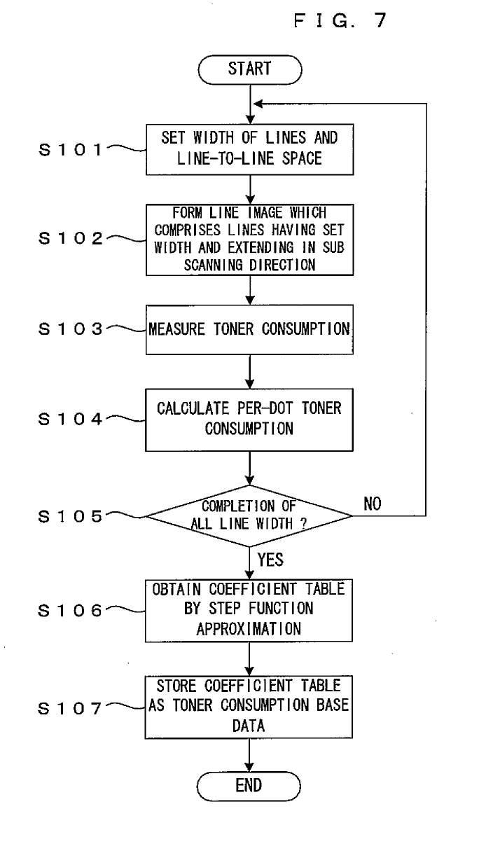

FIG. 7 is a flow chart showing the steps of the method of deriving the toner consumption base data. The processing takes the following procedure. Line images each including plural lines extending in the sub scanning direction are formed in various line widths. The toner consumption on each of the line images is measured. A relation between the line width and the per-dot toner consumption is derived from the measurement results. The magnitude of weight to be applied to the respective dots according to the consecutive dot number in the calculation of toner consumption on the actual image is determined based on the derived relation. This processing need not be performed on every one of the image forming apparatuses. If the toner consumption base data is previously obtained by performing this processing on some of the image forming apparatuses which have the same arrangement, the resultant base data may be applied to the other image forming apparatuses. For instance, the toner consumption base data may be previously obtained by using test machines having the same arrangement as final products, to which the data thus obtained may be applied. Of course, this processing may be performed on each of the apparatuses in preshipment inspection in order to go so far as coping with product-to-product variations of characteristics.

In this processing, a width of the lines constituting the line image and a line-to-line space are set properly (Step S101). The line image, which comprises the lines having the set width and line-to-line space and extending in the sub scanning direction, is formed on the photosensitive member 22 (Step S102). A relation between the line width and the line-to-line space will be described hereinlater.

Next, measurement is taken on the quantity of toner consumed for forming the line image (Step S103). The toner consumption may be measure by any of the following methods, for example. In one method, the toner on the photosensitive member 22 is collected and the mass thereof is measured. In another method, the toner image on the photosensitive member 22 is transferred to a transfer material whose mass is known and the increase in mass is measured. In still another method, the mass of the developer 4 is determined before and after the image formation and the variation in the mass is detected. In order to reduce measurement errors, a large number of line images may be formed to determine an average value of the toner consumptions. Next, the per-dot toner consumption is calculated from the toner consumption on the entire image and the number of dots constituting the image (excluding dots to which the toner is not made to adhere) (Step S104).

The above processing is repeated with the line width and the line-to-line space changed variedly, whereby the relation between the line width and the per-dot toner consumption is obtained. In the line in the sub scanning direction, the line width thereof is practically equal to the number of consecutive dots in the main scanning direction. Therefore, the relation between the number of consecutive dots and the per-dot toner consumption on the line in the sub scanning direction can be obtained by performing the above processing. This relation is generally represented by the solid curve shown in FIG. 5. This curve is approximated by a step function as will be described hereinlater, so that a coefficient table is obtained (Step S106). The result is stored as the toner consumption base data on the apparatus of interest (Step S107).

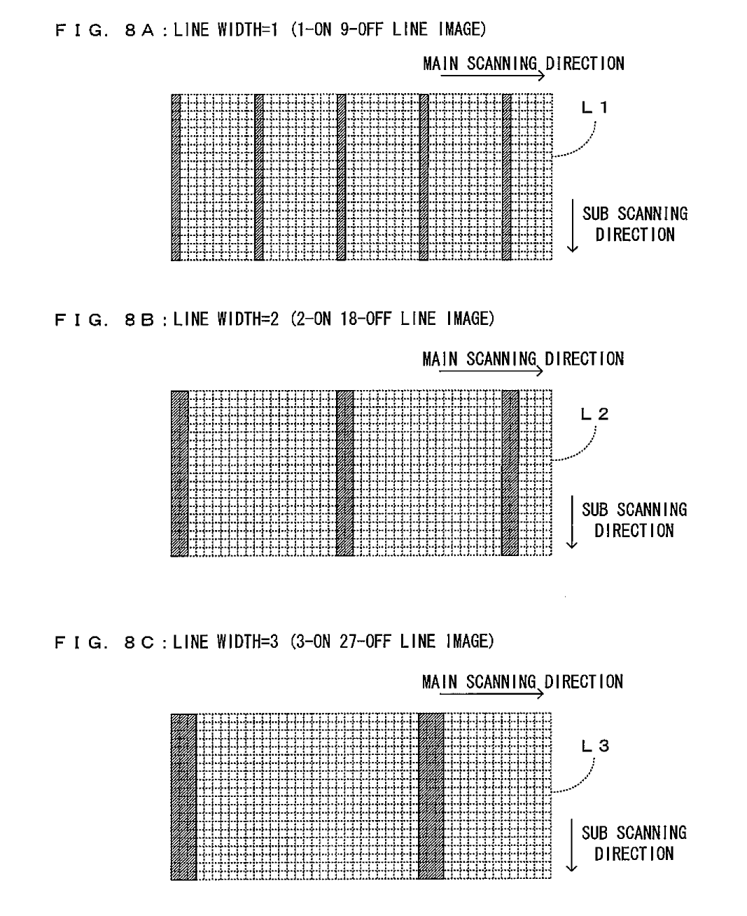

FIG. 8A, FIG. 8B and FIG. 8C are schematic diagrams each showing a relation between the line width and the line-to-line space of a line image. In the processing for deriving the toner consumption base data, the line images are formed while changing the line width and line-to-line space variedly. FIG. 8A, FIG. 8B and FIG. 8C show the details of the line images having respective line widths equivalent to 1 dot, 2 dots and 3 dots. In an image L1 having the line width equivalent to 1 dot, as shown in FIG. 8A, a sufficient space is provided between the lines such that bottoms of potential curves of the lines in a latent image profile may not interfere with each other. In this case, the line image is a so-called 1-on 9-off line image having a line-to-line space equivalent to 9 dots. Hence, an area percentage of the dots in the entire line image L1, or a so-called printing duty thereof is 10%. Normal images principally composed of characters and lines are generally said to have printing duties on the order of 5%. It is desirable that the line image of this example has a printing duty near 5%.

FIG. 8B shows the case where the line width is equivalent to 2 dots. In this case, the line width is doubled and accordingly, the line-to-line space is also doubled or is equivalent to 18 dots. Namely, a 2-on 18-off line image L2 is formed. The line-to-line space is increased in proportion to the increase of the line width so that the total number of dots constituting the entire image is the same as that of the 1-dot line image shown in FIG. 8A. Hence, the printing duty is also the same. Similarly, when the line width is increased to 3 dots, a 3-on 27-off line image L3 having a line-to-line space equivalent to 27 dots is formed as shown in FIG. 8C. In this manner, the printing duties of the images having the different line widths are substantially adjusted to the constant value whereby the variation of measurement results among the images having the different line widths can be reduced. Further, data substantially reflecting practical use conditions can be obtained by taking measurement on the images having printing duties close that of the actual images.

The line width may be set to any value. In a region having a large curvature of a toner consumption curve, however, it is desirable to set the line width to values varied in fine steps. In this example, the toner consumption peaks at a line width equivalent to 5 dots. Therefore, the line width is increased or decreased from 5 dots in small steps and the measurement is taken on the toner consumption with the line width set to each of the values. More specifically, the line width is varied from 1 dot to 9 dots in steps of 1 dot and the measurement is taken with the line width set to each of the values thus varied.

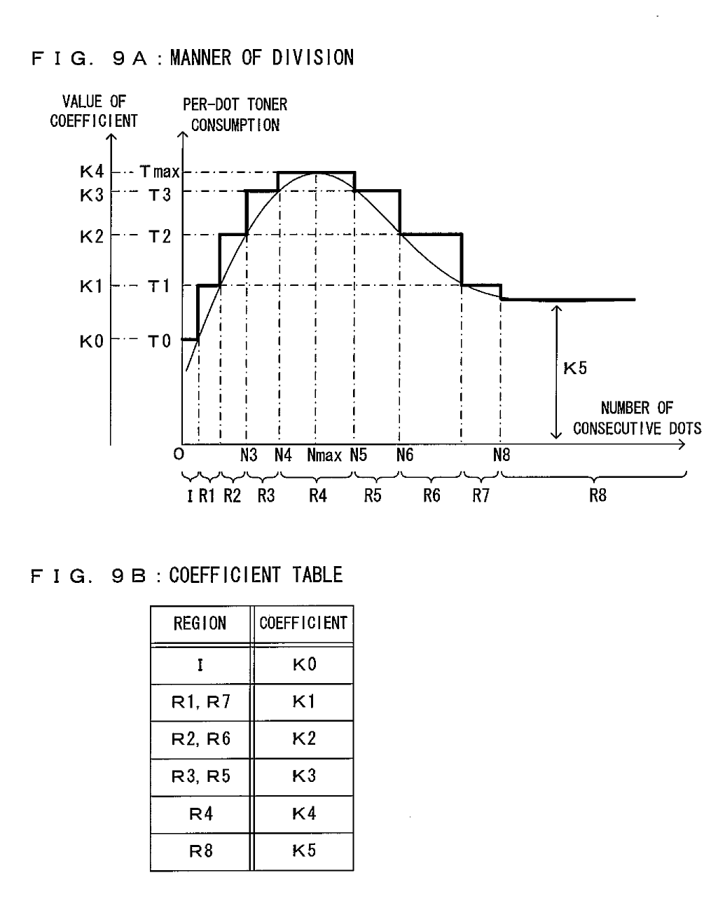

FIG. 9A is a graph showing the principle of generating the coefficient table while FIG. 9B is one of the coefficient tables. As described above, the line images having the respective widths of the lines in the sub scanning direction are formed and the measurement is taken on the respective toner consumptions, whereby a relation between the number of consecutive dots in the main scanning direction and the per-dot toner consumption is obtained as represented by the thin solid curve in FIG. 9A. Hereinafter, this curve will be referred to as the “toner consumption curve”. The abscissa (the number of consecutive dots) is divided into plural regions I, R1 to R8. The division is executed as follow.

First, a consecutive dot number Nmax at which the toner consumption takes the maximum value Tmax is determined. A region R4 including the value Nmax is defined. The lower limit N4 and the upper limit N5 of the region R4 are defined as follows. A value T3 slightly smaller than the maximum value Tmax of the toner consumption is set. Consecutive dot numbers N4 and N5 which take this value T3 on the toner consumption curve are defined as the upper limit and the lower limit of the region R4, respectively.

Next, regions R3 and R5 which adjoin this region R4 are defined as follows. A value T2 slightly smaller than the value T3 of the toner consumption is set. The regions R3 and R5 are each defined to include all the consecutive dot numbers that take values of the toner consumption in the T2 to T3 range on the toner consumption curve. Namely, the region R3 is defined to include consecutive dot numbers in the N3 to N4 range in which the value of the consecutive dots is N4 or less and the values of the toner consumption is T2 or more. Likewise, the region R5 is defined to include consecutive dot numbers in the N5 to N6 range in which the value of consecutive dots is N5 or more and the value of the toner consumption is T2 or more. In a similar manner, further outer regions R2, R6 and the like are defined in turn.

Regions corresponding to the both ends of the toner consumption curve are processed exceptionally. In a region where the consecutive dot number exceeds a certain value, the toner consumption is substantially at a constant value. Therefore, a region including consecutive dot numbers of N8 or more which take the substantially constant value of the toner consumption is defined as one region R8. On the other hand, a region including small consecutive dot numbers is defined as follows. A predetermined region including a consecutive dot number of 1, such as including consecutive dot numbers in a range between 0 and 2 dots, is defined as one region I. This region is provided in order to overcome a problem that an isolated dot (a dot without any adjoining dot in the main scanning direction and isolated) is modulated in width by the signal processing performed by the edge detecting and correcting section 152 and the half-toning section 154 of the signal processor shown in FIG. 3 so that the isolated dot does not always have a 1-dot width.

A weighting coefficient corresponding to a weighted amount of dot is defined for each of the regions thus defined. Specifically, a value corresponding to the maximum value Tmax on the toner consumption curve is defined as a weighting coefficient K4 for the region R4 including the value Nmax at which the toner consumption peaks. The coefficient K4 may be obtained by properly scaling the maximum value Tmax of the toner consumption.

A coefficient K3 for the region R3 is defined by a value obtained by scaling the maximum value T3 on the toner consumption curve in this region R3. Similarly, a weighting coefficient for each of the other regions may be defined by a value corresponding to the maximum value on the toner consumption curve in the region of interest. It is noted here that the regions R3 and R5 adjoining the region R4 including the maximum value of the toner consumption shares the maximum value T3 of the toner consumption in their regions. Hence, the common coefficient K3 may be assigned to both of the regions R3 and R5. This is also applied to a pair of the outer regions R2 and R6 and to a pair of the further outer regions R1 and R7. Therefore, the same coefficients K2 and K1 may be assigned to the respective pairs of regions.

For the region I corresponding to the isolated dot, a value corresponding to the maximum value T0 of the toner consumption in this region is defined as a coefficient K0. For the region R8 where the toner consumption is substantially at the constant value, a value equivalent to the constant value is defined as a coefficient K5 In this manner, one weighting coefficient is defined for each of the regions and the coefficient table shown in FIG. 9B is obtained.

Dividing the consecutive dot numbers into the plural regions and assigning the individual weighting coefficients to the respective regions is equivalent to approximating the toner consumption curve by multiple step functions as indicated by the thick solid line in FIG. 9A. By performing such an approximation, the toner consumption curve can be represented by a small amount of data. Therefore, the toner consumption calculation based on this curve can be accomplished using a relatively easy operation.

In this example, the value corresponding to the maximum value of the toner consumption in each of the regions is defined as the weighting coefficient for the region of interest. Alternatively, an average or median of the toner consumptions in a region may also be defined as a weighting coefficient therefor. In a case where the weighting coefficient is the value corresponding to the maximum value of the toner consumption in each region, a toner consumption calculated using this coefficient is slightly greater than an actual toner consumption. This is advantageous in avoiding a problem in the management of residual toner quantity that the calculated quantity of residual toner is of a greater value than the actual quantity of residual toner. In a case where the weighting coefficient is equivalent to the average or median of the toner consumptions in each region, the calculation of toner consumption on an image comprising a mixture of a variety of consecutive dot numbers can give a value closer to an actual value of toner consumption.

In the above example, the toner consumption curve is approximated by the step functions whereby the curve is expressed using the reduced amount of data. Alternatively, the curve may also be expressed by broken line approximation or approximation using any other function. In this case, a parameter representing the approximated broken line or the function is stored as the toner consumption base data.

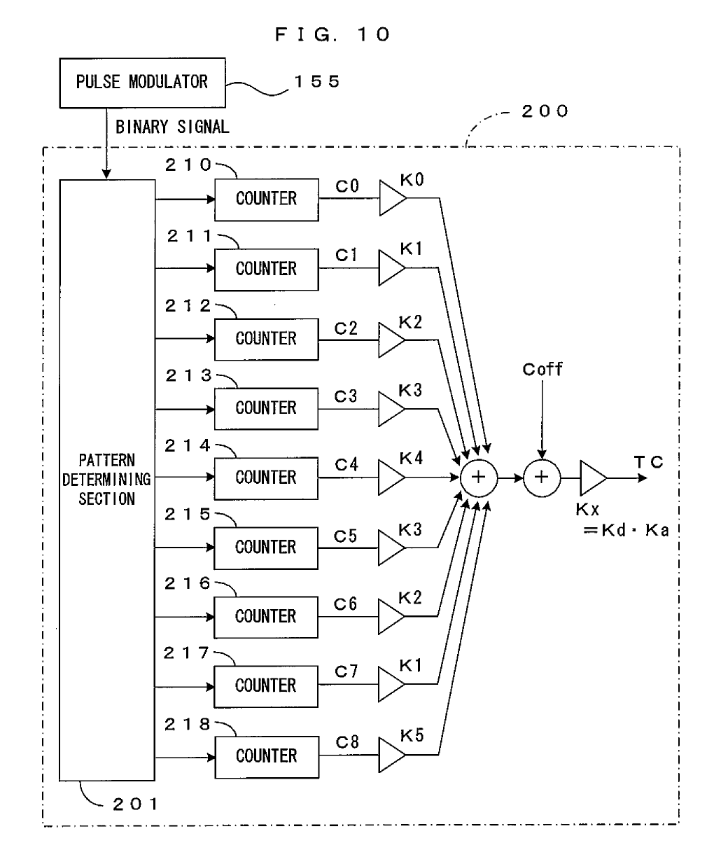

Next, description is made on a technique for calculating a quantity of toner consumed for image formation by using the toner consumption base data thus obtained. The coefficient table data acquired by the above-described processing is installed in the toner counter 200 disposed in each image forming apparatus so as to be used for calculating the toner consumption. The toner counter 200 can be implemented in software or hardware. In either case, the toner counter may have a configuration implementing a model shown in FIG. 10, for example. In a case where the toner counter is implemented in software, for example, the toner consumption base data acquired by the above-described processing may be stored as a table in a storage device such as the ROM 106.

FIG. 10 is a diagram showing a model of the toner counter. The toner counter 200 of this model comprises a pattern determining section 201 which determines a pattern of consecutive dots from the binary signal outputted from the pulse modulator 155. This pattern determining section 201 determines from the supplied binary signal the consecutiveness of dots in the main scanning direction. More specifically, out of the signals expressed in binary form, the number of consecutive numerical values (e.g., 1) corresponding to the activation of laser may be counted, for example. Otherwise, the binary signals may be regarded as a PWM pulse string and a value given by dividing the pulse width by a predetermined unit time (laser-on time for forming 1 dot) may be used as the number of consecutive dots.

The toner counter 200 further comprises counters 210 to 218 for discretely counting the dot numbers belonging to the respective regions of FIG. 9A based on the result given by the pattern determining section 201. Of these, the counter 210 counts the number of dots belonging to the above-described region I, namely the isolated dots. For each page of image, the counter outputs a count of the isolated dots in the entire image as a count value C0. The counter 211 counts the number of dots belonging to the region R1 and outputs a count of the dots as a count value C1. Similarly, the other counters 212 to 218 count the respective numbers of dots belonging to the regions R2 to R8 and outputs respective count values C2 to C8 on a per-page basis.

The count values C0 to C8 obtained by the counters are respectively multiplied by the weighting coefficients K0 to K5 of the above-described toner consumption base data. More specifically, the count values C0 to C4 are multiplied by the coefficients K0 to K4, respectively. The count values C5, C6, C7, C8 are multiplied by the coefficients K3, K2, K1, K5, respectively. All the resultant products are added up. Thus, the numbers of dots constituting one page of image are weighted according to the consecutiveness thereof in the main scanning direction and are integrated.

A predetermined constant Coff is added to the integrated value. This constant Coff is a value equivalent to a per-page quantity of toner consumed by fogging wherein the toner also adheres to dotless portions. The constant Coff can be previously determined by experiment wherein the image forming operation is performed without forming any dot at all or without irradiating the laser beam on the photosensitive member 22.

A value obtained by multiplying the resultant sum by a correction coefficient Kx may be used as a toner consumption TC for one page of image. This correction coefficient Kx is represented by a product of a density coefficient Kd and a deterioration coefficient Ka defined independently. In a case where the apparatus is adapted to increase or decrease the image density through adjustment of image forming conditions, the density coefficient Kd is a parameter for compensating for the increase or decrease of toner consumption due to the increase or decrease of the image density. The density coefficient Kd has a default value of 1.0 corresponding to a standard density. When the image density is adjusted to a higher density than the standard density, the density coefficient Kd is set to a value greater than 1. When the image density is adjusted to a lower density, the density coefficient Kd is set to a value smaller than 1. The deterioration coefficient Ka is a parameter for coping with a property that the toner consumption varies depending upon the degree of toner deterioration although the images are formed under the same image forming conditions.

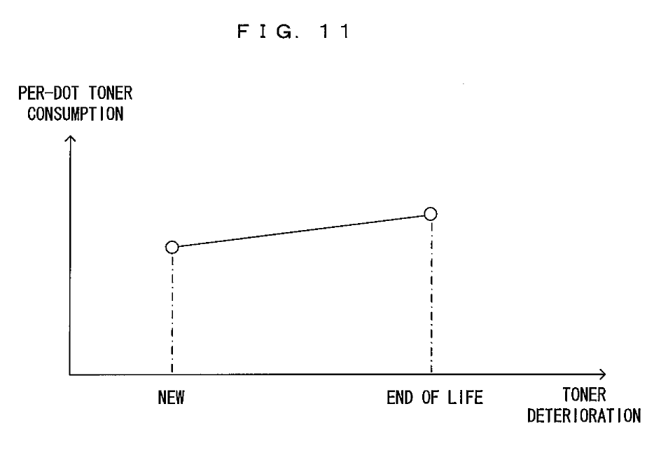

FIG. 11 is a graph showing a relation between the toner deterioration and the toner consumption. As shown in FIG. 11, the per-dot toner consumption varies between when the toner is new and when the toner is at the end of life. In general, the closer is the end of life, the greater is the toner consumption. This is probably because the toner in the developer is changed in the particle size distribution or the characteristics, such as fluidity and charge, in the course of use thereof. The change in the toner characteristics is promoted not only by a factor that the toner is used for image development but also by a factor that the toner T is repeatedly rubbed on and scraped off from the developing roller 41 in sliding contact with the feed roller 42, as shown in FIG. 1. Accordingly, the increase of toner consumption due to the toner deterioration is substantially proportional to the operating time of the developer 4. Hence, the deterioration coefficient Ka has its initial value set to 1.0, from which the factor is increased little by little in proportion to the cumulative of printed pages corresponding to the operation time of the developer 4.

It is possible to determine this deterioration coefficient Ka by performing plural times the processing for deriving the toner consumption base data, shown in FIG. 7, as varying the degree of toner deterioration each time. For instance, the processing for deriving the toner consumption base data shown in FIG. 7 is conducted when the toner is new and when the toner is close to the end of life. A gradient of the deterioration coefficient Ka can be determined by calculating a ratio between measurement results on the line images having the same width.

According to the embodiment as described above, the exposure unit 6 and the developer 4 function as an “exposing device” and a “developing device” of the invention, respectively. The toner counter 200 functions as a “toner consumption calculator” of the invention.

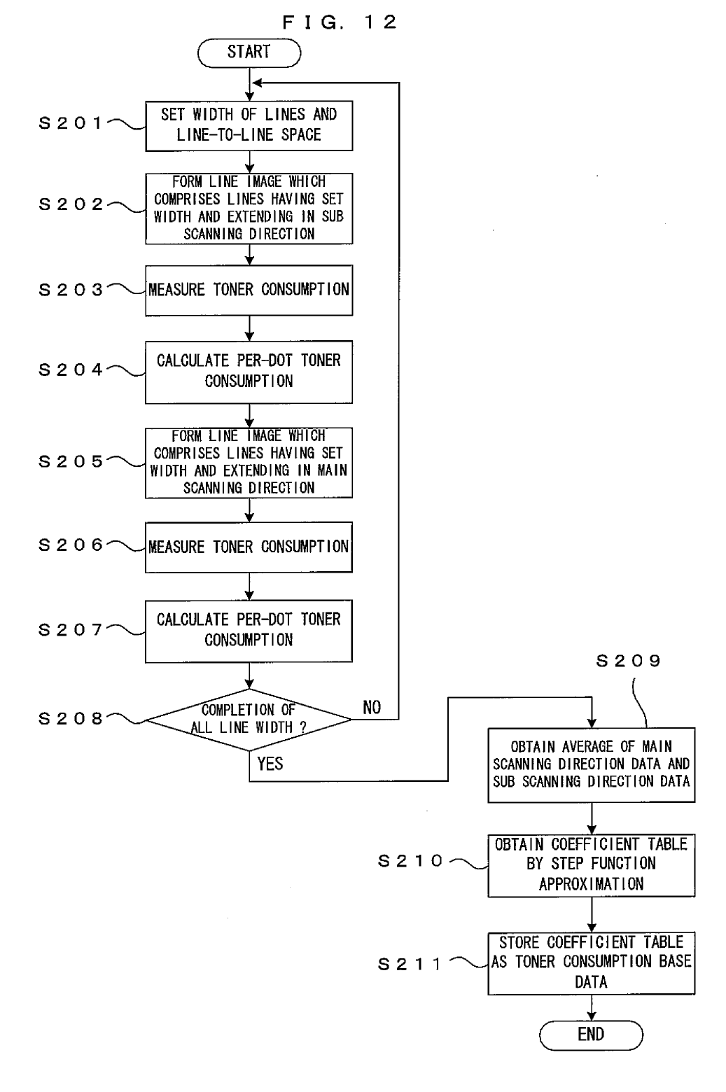

According to the embodiment, Steps S101 to S04 of the processing for deriving the toner consumption base data shown in FIG. 7 constitute a “measuring step” of the invention. In a processing for deriving the toner consumption base data shown in FIG. 12, Steps S202 to S204 constitute the “measuring step” of the invention, while Steps S205 to S207 thereof constitute a “correction data deriving step” of the invention.

According to the toner consumption calculation technique, as described above, the toner consumption base data is acquired from the measurement results of toner consumptions on the line images having different line widths and extending in the sub scanning direction. The toner consumption is calculated based on the toner consumption base data thus acquired. More specifically, the toner consumption on the actual image is calculated as follows. The individual dots constituting the image are weighted according to the consecutive dot number in the main scanning direction and are counted. Then, the toner consumption is calculated from the count value. As described above, the toner consumption on each and every one of the dots varies depending upon the consecutiveness thereof in the main scanning direction and in the sub scanning direction.

The above toner consumption calculation technique addresses this problem as follows. The contribution of the dot consecutiveness in the main scanning direction to the toner consumption is reflected in the calculation result of toner consumption by weighting the individual dots variedly according to the consecutive dot number in the main scanning direction. On the other hand, the contribution of the dot consecutiveness in the sub scanning direction to the toner consumption is reflected in the calculation result of toner consumption by defining the magnitude of weighed amount of the respective dots based on the measurement result of toner consumption on the line in the sub scanning direction. In this manner, the toner consumption calculation technique considers the dot consecutiveness in both of the main scanning direction and the sub scanning direction. Therefore, this technique can provide a more accurate calculation of the toner consumption than the case where only the dot consecutiveness in the main scanning direction is considered. Particularly on the monochromatic images principally composed of characters and lines, such as of common business documents, the toner consumption can be accurately determined by using the above-described toner consumption calculation technique. In the images of this type, even a fine line in the main scanning direction is often formed in a width of several dots in the interest of enhancing visibility. In most cases, therefore, each dot has adjoining dot(s) in the sub scanning direction.

The above-described toner consumption calculation technique offers the following advantage. If the toner consumption base data is previously acquired from the line images in the sub scanning direction, the subsequent processing for calculating the toner consumption may be performed the same way as in the conventional technique wherein only the dot consecutiveness in the main scanning direction is detected and used in the calculation of toner consumption. The subsequent calculation processing is simplified because it does not require the detection of dot consecutiveness in the sub scanning direction.

In the image forming apparatus according to the invention, the toner consumption calculator may take a procedure wherein the dots constituting the toner image are counted as classified into groups according to the consecutive dot numbers in the main scanning direction so as to determine the dot numbers of the respective groups, wherein the respective count values of the dot groups are multiplied by the respective weighting coefficients and the resultant products are added up to obtain a total sum, and wherein the toner consumption is calculated based on the total sum. It is also possible to calculate the toner consumption with high accuracies by using such a simple method.

The following fact is known about a relation between the number of consecutive dots and the toner consumption. As the number of consecutive dots is increased from the minimum, the toner consumption is first increased to peak at a certain number of consecutive dots and then is progressively decreased to approach a constant value. Therefore, the above weighting coefficient may be defined to take the maximum value for the certain consecutive dot number and to take smaller values for the greater consecutive dot numbers and for the smaller consecutive dot numbers. Further, the weighting coefficient may also be defined to take a constant value for the consecutive dot numbers above a certain value.

The above weighting coefficient may also be set for each of the regions of consecutive dot numbers which are divided in plural steps. This approach requires as many weighing coefficients as the regions to be defined and hence, the amount of data is reduced and the calculation processing is simplified. Furthermore, if the weighting coefficient for each of the regions is defined to take the maximum value of the toner consumption base data on the region of interest, a calculation error resulting from the simplification appears in a manner that the calculational toner consumption has a greater value than the actual toner consumption. If the calculational toner consumption has a smaller value than the actual toner consumption due to the error, a problem in the management of consumable article may arise that the calculational value indicates some remaining toner although no toner is left actually. This problem can be avoided by making the calculational toner consumption greater than the actual toner consumption.

More specifically, the per-dot toner consumptions ranging from the minimum to the maximum may be divided into plural levels, while the regions of consecutive dot numbers may be defined in a manner that consecutive dot numbers belonging to one level of toner consumption have a value of one region of consecutive dot numbers. In this manner, the consecutive dot numbers are classified by the value of toner consumption instead of the numerical value of the consecutive dot number, whereby the calculation having one weighting coefficient applied to one region is further increased in accuracy.

The above toner consumption calculator may also be adapted to vary the magnitude of weighted amount according to the degree of toner deterioration. If the toner images are formed under the same conditions, the toner consumption varies with the deterioration of the toner. Hence, the magnitude of weighted amount is varied according to the degree of toner deterioration so that the toner consumption can be calculated with higher accuracies.

Hereat, the above line-patterned toner image may comprise a line extending in the moving direction (the sub scanning direction), for example. In this approach, every one of the dots constituting the line has a dot/dots adjoining in the sub scanning direction so that the consecutiveness of dots in the sub scanning direction can be assuredly reflected in the toner consumption base data. Further, the line width depends only upon the number of consecutive dots in the main scanning direction. Therefore, the “relation between the line width and the per-dot toner consumption” can be handled the same way as the “relation between the number of consecutive dots in the main scanning direction and the per-dot toner consumption”.

In this case, the invention may further comprise performing a correction data deriving step in which a line-patterned toner image, which includes a line having a predetermined line width and extending in the scanning direction, is formed and a relation between the line width of the line-patterned toner image and the per-dot toner consumption is determined. The data, which is acquired by the measuring step and represents the relation between the line width in the moving direction and the per-dot toner consumption, may be corrected with the data acquired by the correction data deriving step and representing the relation between the line width in the scanning direction and the per-dot toner consumption. The corrected data may be used as the toner consumption base data.

If the line extending in the main scanning direction and the line extending in the sub scanning direction have the same width, these lines have some difference in the per-dot toner consumption. In the actual image, the dots are arranged in various manners in the main scanning direction and sub scanning direction. The image also includes some lines having no component in the sub scanning direction. In order to further reduce the calculation error in an image including a large number of such lines, it is preferred that data representing the relation between the line width in the sub scanning direction and the toner consumption is corrected with data representing the relation between the line width in the main scanning direction and the toner consumption, and the corrected data is used.

For instance, an average of the toner consumptions on lines having the same width and extending in the main scanning direction and in the sub scanning direction may be used as the toner consumption on the line having the width in question. This is effective to increase the accuracy of the calculation of toner consumption on an image in which the lines in the main scanning direction and in the sub scanning direction appear substantially at the same frequency. Alternatively, the greater one of the toner consumptions on these lines may be used as the toner consumption on the line having the width in question. In the calculation based on the data thus acquired, a calculated value of toner consumption may be greater than a true value of toner consumption but is never be smaller than the true value. This is advantageous in a case where the management of residual toner quantity is carried out based on the calculation result of toner consumption. This is because the problem that no toner is actually left although the calculational value indicates some remaining toner can be avoided by preventing the calculated value of toner consumption from having a smaller value than the true value.

In the measuring step, it is preferred to form the line-patterned toner image comprising plural lines in parallel relation and having the same width. Further, it is preferred that the individual line-patterned patch images formed in the respective measuring steps have an equalized area percentage of dots in the entire line-patterned patch image. This method permits the line-patterned toner images of different line widths to have a substantially constant number of dots constituting the entire image. Hence, the relation between the line width and the toner consumption can be determined with even higher accuracies.

The data representing the relation between the line width and the per-dot toner consumption acquired by the measuring step may be approximated by broken lines or step functions, and then the approximated data may be used as the toner consumption base data.

In the image forming apparatus to which the toner consumption calculation technique based on the toner consumption base data of the invention is applicable, even toner images of the same contents may vary in the toner consumption as a result of the change in toner characteristics caused by deterioration. This problem may be addressed as follows. The above measuring step is performed plural times to form the line images of the same width as varying the degree of toner deterioration each time. Data representing the relation between the line width and the per-dot toner consumption and representing the variation of toner consumption according to the varied degree of toner deterioration is acquired from the measurement results. The resultant data is used as the toner consumption base data. This approach copes with the variation of toner consumption caused by the varied degree of toner deterioration. Hence, the toner consumption can be determined with stable accuracies over a period from the initial stage to the end of life of the toner.

It should be noted that the invention is not limited to the embodiment above, but may be modified in various manners in addition to the embodiment above, to the extent not deviating from the object of the invention. For example, although only one pair of weighting coefficients is prepared corresponding to the respective count values of the dot groups, it may be changed according to a set operation mode in the image forming apparatus which can change a resolution, a process speed or the like. This is because the value of the per-dot toner consumption may vary corresponding to the setting of the resolution to the like. By the same token the division of the region may be changed in a like manner.

In the embodiment above, the toner consumption base data is acquired from the measurement result of the toner consumption on the line image comprising the lines extending in the sub scanning direction. This provides a high accuracy of the calculation of the toner consumption particularly on an image including a large number of lines extending in the sub scanning direction. Furthermore, the problem that the actual toner consumption is greater than the calculational toner consumption does not arise. However, it may sometimes be more preferred to adopt the following method in order to obtain a calculation result closer to an actual toner consumption on an image including a large number of very thin lines in the main scanning direction or a half-tone image.

FIG. 12 is a chart showing another example of the method of deriving the toner consumption base data. This deriving method differs from the processing shown in FIG. 7 in that not only the line images in the sub scanning direction but also line images in the main scanning direction are formed and respective toner consumptions thereof are discretely determined and that the toner consumption base data is obtained from the results. Specifically, Steps S201 to S204 are the same as Steps S101 to S104 in FIG. 7, wherein the line images in the sub scanning direction are formed so as to determine the per-dot toner consumption. In this modification, however, the line images in the main scanning direction are formed subsequently so as to determine the per-dot toner consumption the same way (Steps S205 to S207). It is desirable that the line image formed at this time has the same line width and line-to-line space as the line image in the sub scanning direction so as to have the same printing duty.

This processing is repeated while changing the line width variedly (Step S208). Of the measurement results obtained from the line images in the main scanning direction and the sub scanning direction, an average of the measurements of a respective pair of line images having the same line width is determined (Step S209). The toner consumption base data is generated based on the average values thus determined (Steps S210, S211). By using the average value of the two data items, the toner consumption on a general image comprising a mixture of various dot strings in the main scanning direction and the sub scanning direction can be calculated with increased accuracies. Alternatively, the greater value of the two data items may be used thereby preventing the calculational toner consumption from having a smaller value than the actual consumption. In short, the object of this modification consists in that the measurement results of toner consumption on the lines in the sub scanning direction are not directly used as the toner consumption base data but that the measurement results are corrected with the measurement results of toner consumption on the lines in the main scanning direction before used as the toner consumption base data.

In the embodiments above, the line image extending in the sub scanning direction, namely the line image without a component in the main scanning direction is formed. From the viewpoint of the object of the invention, however, what is required is to form a line image at least having a component in the sub scanning direction. In this view, a slant line image also having the component in the main scanning direction may be formed. It is noted however that of the dots constituting the slant line, some have adjoining dots in the sub scanning direction while the others do not have such dots. This may possibly lead to a more complicated processing on the measurement results. It is therefore desirable that the component in the main scanning direction is not increased so much.

While the images having only the components in the sub scanning direction are formed repeatedly, a condition wherein the latent image formed at a particular position on the photosensitive member 22 is developed with the toner carried on a particular area of the developing roller 41 continues to exist all the time. Hence, locally varied characteristics of the photosensitive member 22 and developing roller 41 may affect the toner consumption base data. In order to suppress such an influence, the line image may be configured as follows.

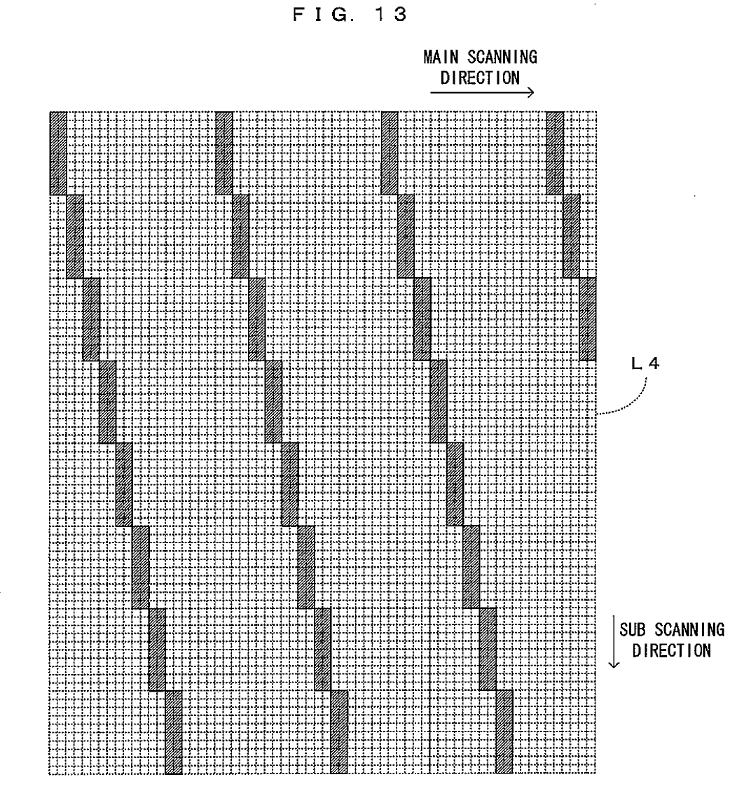

FIG. 13 is a diagram showing another example of the line image. In a line image L4 of FIG. 13, lines each having a constant line width in the main scanning direction and extending in the sub scanning direction are formed in a predetermined length as shifted in their positions in the main scanning direction each time. Thus, the entire line image L4 is formed by evenly using the overall surfaces of the photosensitive member 22 and developing roller 41. Accordingly, the above-described problem can be avoided. In addition, the printing duty of the entire image is not changed if the image is formed in this manner. In a macroscopic view, such a line image L4 may be considered as an assembly of slant lines.

The image forming apparatus of the above embodiment is a monochromatic image forming apparatus comprising only one developer storing a black toner. However, the invention is not limited to this but is also applicable to all types of image forming apparatuses for forming images by using the toner(s), such as an apparatus for forming a color image by using toners of plural colors. In this case, the toner consumption calculation technique of the invention may be applied to the all color toners or to only the black toner. Further, the toner consumption calculation technique of the invention may be applied to the apparatus only when the monochromatic image is formed because the invention can provide a particularly excellent accuracy of calculation on such an image.

Although the invention has been described with reference to specific embodiments, this description is not meant to be construed in a limiting sense. Various modifications of the disclosed embodiment, as well as other embodiments of the present invention, will become apparent to persons skilled in the art upon reference to the description of the invention. It is therefore contemplated that the appended claims will cover any such modifications or embodiments as fall within the true scope of the invention.

What is claimed is:

1. An image forming apparatus comprising:
a photosensitive member that revolvably moves in a moving direction;
an exposure device that exposes a surface of the photosensitive member to a light beam which is controllably activated according to an image signal and scanned on the surface of the photosensitive member in a scanning direction perpendicular to the moving direction thereof, thereby forming an electrostatic latent image on the photosensitive member in correspondence to the image signal;
a developing device that develops the electrostatic latent image with a toner to form a toner image; and
a toner consumption calculator that counts the number of dots constituting the toner image based on the image signal and calculates a quantity of toner consumed by the developing device based on the resultant count value, wherein
the toner consumption calculator calculates a toner consumption based on the count value of the dots weighted according to the number of consecutive dots in the scanning direction, and
the magnitude of weighted amount is determined based on toner consumption base data representing a toner consumption on a line-patterned toner image which has a line pattern including a component in the moving direction and being formed with a line width corresponding to a consecutive dot number.

2. The image forming apparatus according to claim 1, wherein the toner consumption calculator classifies the individual dots constituting the toner image into regions by the number of consecutive dots in the scanning direction, counts the number of dots on a per-region basis, multiplies the count value of each region by a weighting coefficient corresponding to the region of interest, sums up the resultant products and calculates the toner consumption based on the total sum.

3. The image forming apparatus according to claim 2, wherein the weighting coefficient takes the maximum value for a predetermined consecutive dot number while takes a smaller value for a greater consecutive dot number than the predetermined consecutive dot number and for a smaller consecutive dot number than the predetermined consecutive dot number.

4. The image forming apparatus according to claim 3, wherein the weighting coefficient takes a constant value for a consecutive dot number being a predetermined value or greater.

5. The image forming apparatus according to claim 2, wherein the weighting coefficient is set for each of the regions divided in plural steps and the weighting coefficient for each region has a value corresponding to the maximum value of the per-dot toner consumption in the region of interest.

6. The image forming apparatus according to claim 5, wherein
the per-dot toner consumptions ranging from the minimum value to the maximum value are divided into plural levels, and
the regions of consecutive dot numbers are defined in a manner that consecutive dot numbers belonging to one level of toner consumption have a value of one region of consecutive dot number.

7. The image forming apparatus according to claim 1, wherein the toner consumption calculator varies the magnitude of weighted amount according to the degree of toner deterioration.

8. A method of calculating a toner consumption in an image forming apparatus which forms an electrostatic latent image corresponding to an image signal on a surface of a revolvably moved photosensitive member by scanning a light beam, controllably activated according to the image signal, on the surface of the photosensitive member in a direction perpendicular to the moving direction of the surface of the photosensitive member and which forms a toner image by developing the electrostatic latent image with a toner, the method comprising:
counting the number of dots constituting the toner image based on the image signal;
weighting the resultant count value according to the number of consecutive dots in the scanning direction of the light beam; and
obtaining a toner consumption based on the weighted value, wherein
the magnitude of weighted amount is determined based on toner consumption base data representing a toner consumption on a line-patterned toner image formed in a line pattern having a line width corresponding to a consecutive dot number and including a component in the moving direction.

9. A method of deriving toner consumption base data for use in an image forming apparatus which forms an electrostatic latent image corresponding to an image signal on a surface of a revolvably moved photosensitive member by scanning a light beam, controllably activated according to the image signal, on the surface of the photosensitive member in a scanning direction perpendicular to the moving direction of the surface of the photosensitive member, which forms a toner image by developing the electrostatic latent image with a toner, and which calculates a toner consumption based on a count value of dots constituting the toner image, the count value weighted based on toner consumption base data corresponding to per-dot toner consumption, the method comprising:
performing a measuring step of forming, on the surface of the photosensitive member, a line-patterned toner image which has a predetermined line width and includes a component in the moving direction, measuring a quantity of toner consumed for forming the line-patterned toner image, and determining from the measurement result a per-dot toner consumption on the line-patterned toner image, wherein
the measuring step is repeated while the line width is varied in plural values, and
data, which is acquired by these measuring steps and represents a relation between the line width and the per-dot toner consumption, is used as the toner consumption base data.

10. The method of deriving toner consumption base data according to claim 9, wherein the line-patterned toner image includes a line extending in the moving direction.

11. The method of deriving toner consumption base data according to claim 10, further comprising performing a correction data deriving step in which a line-patterned toner image, which includes a line having a predetermined line width and extending in the scanning direction, is formed and a relation between the line width of the line-patterned toner image and the per-dot toner consumption is determined, wherein
the data, which is acquired by the measuring step and represents the relation between the line width in the moving direction and the per-dot toner consumption, is corrected with the data acquired by the correction data deriving step and representing the relation between the line width in the scanning direction and the per-dot toner consumption, and the corrected data is used as the toner consumption base data.

12. The method of deriving toner consumption base data according to claim 9, wherein
in the measuring step the line-patterned toner image, which includes plural lines extending in mutually parallel relation and having the same line width, is formed, and
the line-patterned patch images respectively formed in different measuring steps have an equalized area percentage of dots in the entire line-patterned patch image.

13. The method of deriving toner consumption base data according to claim 9, wherein
data representing the relation between the line width and the per-dot toner consumption acquired by the measuring step is approximated by broken lines or step functions, and
the approximated data is used as the toner consumption base data.

14. The method of deriving toner consumption base data according to claim 9, wherein
the measuring step with the line width set to a constant value is performed plural times while changing the degree of toner deterioration variedly, and
data, which is acquired from the results of the measuring steps and represents a relation between the line width and the per-dot toner consumption and the variation of the toner consumption according to the varied degree of toner deterioration, is used as the toner consumption base data.
